(19) United States
(12) Patent Application Publication
(10) Pub. No.: US 2011/0189054 A1
(43) Pub. Date: Aug. 4, 2011

(54) FLUIDIZED BED GASIFIER WITH SOLIDS DISCHARGE AND CLASSIFICATION DEVICE

(75) Inventor: Tsung-Yao Robert Sheng, Hansdale, IL (US)

(73) Assignee: SYNTHESIS ENERGY SYSTEMS, INC., Houston, TX (US)

(21) Appl. No.: 12/996,017

(22) PCT Filed: Jun. 5, 2009
(86) PCT No.: PCT/US09/46336

§ 371 Date: Jan. 30, 2011

Related U.S. Application Data
(60) Provisional application No. 61/059,015, filed on Jun. 5, 2008.

(51) Int. Cl. B01J 8/18; B01J 8/00

(52) U.S. Cl. 422/139; 422/310

(57) ABSTRACT

An apparatus for withdrawing solids from a fluidized bed reactor comprises a venturi tube connected to the stem end of a funnel-shaped distribution plate, and a center jet pipe enclosed within the venturi, wherein a jet stream of feed gas is delivered above the venturi throat. Preferably, the distribution plate is equipped with multiple horizontally- or downwardly-oriented grid holes through which the feed gases flow and enter the fluidized bed, which holes may be covered by metal plates to prevent solids from weeping through grid holes and falling into the plenum below the distribution plate. The venturi is preferably engineered to be readily removable from the rest of the gasifier reactor for repair or replacement. Also provided is a fluidized bed reactor comprising the above apparatus.

### FIELD OF THE INVENTION

The present invention relates to methods and apparatuses of distributing feed gas to a fluidized bed reactor and discharging solids residues therefrom.

### BACKGROUND OF THE INVENTION

Solids residues generated from fluidized bed gasifiers operated at high temperatures and pressures need to be discharged from the gasifiers in a controllable and steady manner to maintain adequate bed height and solids residence time required for gasification reactions. Conventional underflow discharge systems for fluidized bed gasifiers operated at high temperatures and pressures using control valves or mechanical feeders frequently result in erratic solids flow rate and high erosions to mechanical parts of discharge devices. The mechanical design, construction and operation of control valve and mechanical feeder are complex and require frequent repairs and replacements. The conventional discharge system often results in unscheduled shutdowns and affects the performance and reliability of the gasifier system.

Solids residues discharge from fluidized bed gasifier at high temperature and pressure using a venturi tube are known in the art, see e.g. U.S. Pat. No. 4,435,364, to Vorres and U.S. Pat. No. 4,023,280, to Schora, et al. Specifically, below the fluidized bed and at the bottom of the downwardly extending passage of the reaction vessel, a constriction is provided having an opening defining a venturi to guide the upflowing feed gas entering the fluidized bed and the downflowing solids residues discharging from the fluidized bed. The flow rate of solids discharged from the fluidized bed is controlled by the velocity of the upflowing gas without the need to use a control valve or mechanical feeder.

The venturi throat portion is operated not only under high temperature and high pressure, but also under constant bombardment of high velocity gas and solids streams. As a consequence, the venturi tube is subjected to high erosion and requires frequent and expensive repairs or replacements, which result in frequent or prolonged shutdowns.

There is therefore a need to have a system and a method to discharge a controlled amount of unreacted or incompletely reacted residue solids from the fluidized bed gasifier operated at high temperature and pressure, without the need to use any mechanical devices such as valves or feeders.

Perforated plates are commonly used to distribute feed gases required to fluidize the feed solids in gasifiers. Proper fluidization of bed solids promotes gas and solids contact as required for high conversion and yield. Solids in fluidized bed, however, commonly migrate through the openings of the distribution plate and fall into the plenum under the distribution plate causing adverse problems such as combustion in the plenum.

There is therefore a need to have a system and a method to more uniformly distribute the feed gases to the gasifier and to minimize the amount of fluidized bed solids migrating to the plenum below the distribution plate to promote the gasifier performance and to prevent undesired combustion in the plenum.

### SUMMARY OF THE INVENTION

The present invention relates to an improved apparatus and method to withdraw solids from a fluidized bed gasifier. The apparatus comprises a venturi with a constricted cylindrical opening, or venturi throat, connected with a conical portion extending upward above the venturi throat and a downward extending conical portion below the venturi throat. The venturi is connected to the bottom of a conical distribution plate where a portion of feed gases is distributed before entering the fluidized bed gasifier.

In one embodiment, the apparatus of the present invention comprises a cylindrical pipe, referred to as the classifier, that is connected to the bottom of the venturi, and a smaller vertical pipe, or the center jet, is located in the center of the classifier and venturi. Solids residues discharged from the fluidized bed gasifier fall into the venturi and flow downward through the annular space between the venturi throat and the center jet and then through the annular space between the classifier and center jet. A portion of the feed gases flows upward through the annular spaces of the classifier and venturi and enters the fluidized bed gasifier.

The apparatus and method of the present invention allows the separation of heavier and larger solids residues from the lighter and smaller solids residues, using the classifier. Larger or heavier residues in the classifier have sufficient downward momentum against the up-flowing feed gases, and can fall down the classifier and discharged out of the classifier. Smaller or lighter residues, in contrast, are re-entrained by the up-flowing gases and returned to the fluidized bed gasifier.

By separating the heavier and larger solids residues from smaller and lighter solids residues, gas and solids reaction is carried out more thoroughly, and higher overall conversions of feed materials are achieved. It is known that as the gasification reactions of carbonaceous feed solids progress, more fully reacted solids become larger or heavier depending on the type of feed materials. The present invention together with the classifier selectively discharge the more fully reacted larger or heavier solids residues from the fluidized bed gasifier, and return the less reacted, smaller or lighter solids to the fluidized bed gasifier, and allow the less reacted solids to have a longer residence time required for more complete gasification reactions.

The present invention further improves overall conversion rate by providing feed gas beneath the classifier. Solids discharged from the venturi throat enter the classifier immediately below the venturi and further react with the up-flowing feed gases.

The present invention also provides a removable venturi design where the eroded venturi can be readily replaced with a spare venturi device thereby shortening the down time and improve the overall availability of the gasifier. As discussed above, the venturi throat is under constant bombardment of high velocity gas and solids streams at high temperature and high pressure, and is subjected to high erosion and requires frequent repairs or replacements causing prolonged shutdowns of the gasifier system.

The present invention further provides an improved apparatus and method to distribute feed gases for fluidized bed gasifier. More specifically, a conically shaped perforated distribution plate or grid is equipped with multiple horizontally- or downwardly-oriented openings or grid holes through which the feed gases flow and enter the fluidized bed. The distribution plate has a cone angle, and the grid holes are sized and spaced, so as to provide a more uniform distribution of feed gases, improved solids circulation pattern, and better gas-solids mixing in the fluidized bed gasifier. In a preferred embodiment, the entrances of the grid holes are placed below the distribution plate, and are covered with certain metal attachments to prevent solids from flowing into the grid holes and falling into the plenum below the distribution plate causing undesired combustion reactions.

### BRIEF DESCRIPTION OF THE DRAWINGS

FIG. 1 is a schematic diagram of a fluidized bed coal gasifier incorporating an integrated solids residue discharge and classification device of the present invention.

FIG. 2 is a schematic diagram of a solids residue discharge device according to one embodiment of the invention.

FIG. 3 is a schematic diagram of a solids residue classification device of the present invention.

FIG. 4 is a schematic diagram of an improved feed gases distribution grid according to one embodiment of the invention.

FIG. 5 is a schematic diagram of an improved feed gases distribution grid according to another embodiment of the invention.

FIG. 6 illustrates one embodiment of a gas distribution plate according to the present invention covered by a metal plate.

### DETAILED DESCRIPTION OF THE INVENTION

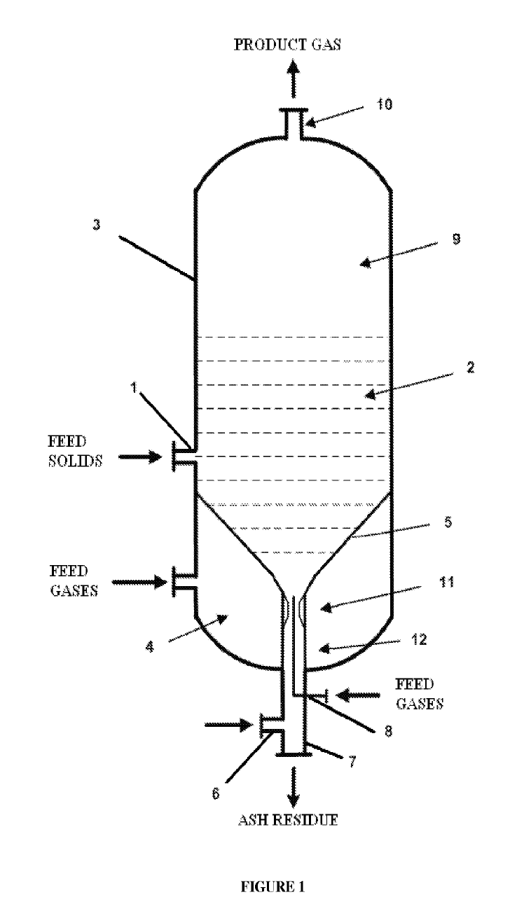

Referring to the figures, the various aspects of the present invention are described in more detail below. FIG. 1 provides a schematic diagram of one embodiment of a fluidized bed gasifier according to the present invention. The fluidized bed gasifier comprises an integrated solids residue discharge and classification device. Solids feed comprising crushed carbonaceous fuels such as coal or biomass is pneumatically or mechanically fed through a feed pipe 1 to the fluidized bed 2 of the gasifier 3. Gaseous feed containing a mixture of steam and oxidant, such as air or oxygen, is injected to the gasifier at three locations: 1) the “grid gas” is injected to the plenum 4 below the distribution grid 5, 2) the “classifier gas” is injected through a connection pipe 6 to the ash discharge line 7, and 3) the “jet gas” is injected through a center jet pipe 8.

The solids feed is reacted with the gaseous feed in the fluidized bed 2 controlled at a specific temperature, pressure and residence time and converted to a combustible gaseous product. The raw product gas ascends through the dense phase fluidized bed 2 and the dilute phase freeboard 9 and exits the gasifier 1 through a discharge nozzle 10. The raw product gas is then fed to the gas cleanup and processing sections.

Solids are discharged from the fluidized bed 2 by the solids residue discharge device 11 and fall into the classification device 12 where less reacted smaller or lighter solids are separated from the more reacted larger or heavier solids residues and re-entrained to the fluidized for further gasification reactions. The larger or heavier solids residues are discharged from the gasifier through the ash discharge pipe 7.

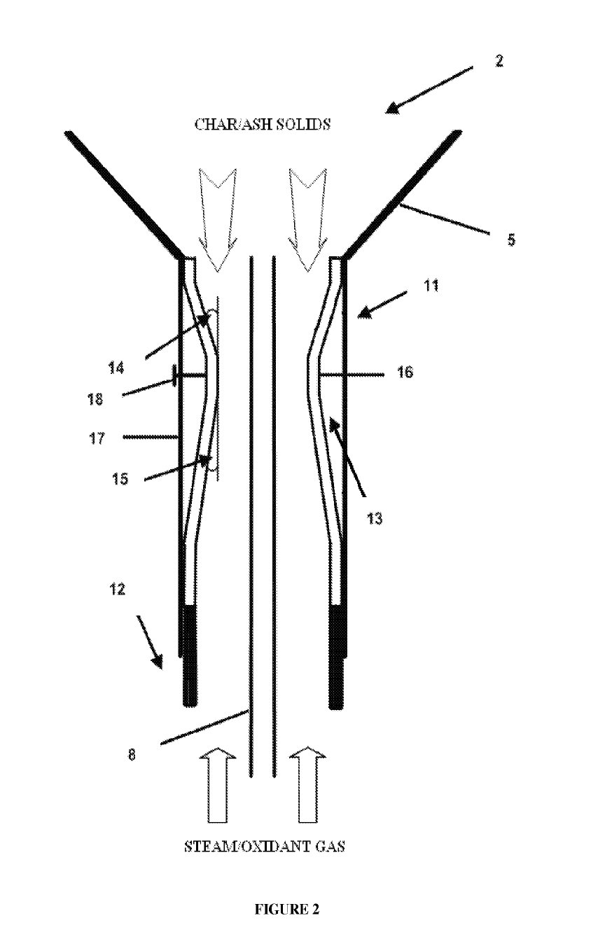

FIG. 2 illustrates in more detail the solids residue discharge device. The primary function of the solids residue discharge device 11 is to discharge a controlled amount of solids from the fluidized bed 2 of the gasifier 3. The classification device 12 separates the less reacted smaller or lighter solids from the more reacted larger or heavier solids residue formed in the fluidized bed 2 and the classifier 12, subsequently returns the less reacted solids to the fluidized bed for more gasification reactions, and discharges the larger or heavier solids residue from the classifier located at the bottom of the gasifier.

The solids residue discharge device comprises a removable venturi insert 13 located inside a cylindrical venturi retainer pipe 17 at the junction of the bottom of the grid 5 and the top of the classifier 12. The venturi insert rests on the top of the classifier and is held in position by a locking device 18. The venturi has a constricted cylindrical opening, or venturi throat 16, connected with an upward extending conical portion above the throat and a downward extending conical portion below the throat. The convergent angle 14 and divergent angle 15 range from 0 to 30 degrees. In one embodiment, the length or height of the venturi throat ranges from 50 to 250 mm, and the ratio of venturi diameter to classifier diameter ranges from 0.2 to 1.0. The diameter of the venturi throat, or the width of the annular space between the venturi throat and center jet, is determined by the gas and solids flow rate, the operating temperature and pressure, and the properties of gas and solids. The flow rate of char/ash solids falling from the fluidized bed 2 down into the venturi 13 is determined by the amount of steam/oxidant feed gases flowing upwards through the annular space between the venturi throat 16 and the center jet pipe 8. The solids residue discharge device uses the flow rate of an upflowing gas mixture through the venturi throat to control the discharge flow rate of char and ash residue solids and the level of the fluidized bed 2 without the need of using control valves or mechanical feeders which are commonly required for the conventional underflow discharge systems.

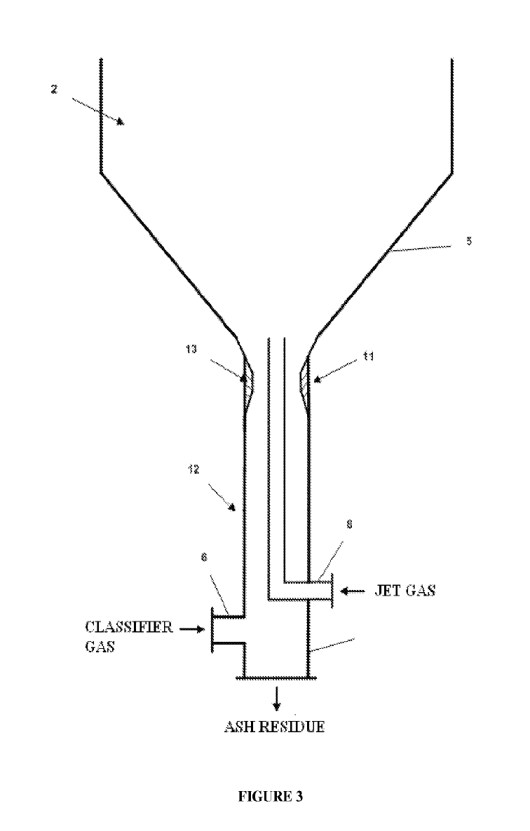

As shown in FIG. 3, classifier 12 comprises a vertical section between the venturi and the inlet elbow of the center jet pipe. Char/ash solids discharged from the venturi fall by gravity into the annular space between the ash discharge pipe 7 and central jet pipe 8. As the solids flow down the classifier 12, the reactions between the un-reacted char and up-flowing feed gas mixture continue inside the classifier, resulting in further caking or sintering of the solids which become bigger or heavier ash residue solids. When the ash residue particles reach a certain size and/or weight, the force of the upflowing gases in the classifier is insufficient to keep the ash residue solids in a suspended or fluidized state, and the ash residue solids fall down to the bottom of the ash discharge line 7. The lighter and/or smaller solids are kept in the classifier or re-entrained to the fluidized bed 2 for more gasification reactions. The classifier has a specific length and diameter to accomplish the final burnout reactions and to achieve high overall conversion of feed solids and can be determined by those skilled in the art. Preferably, the ratio of classifier length to classifier diameter ranges from 5 to 20.

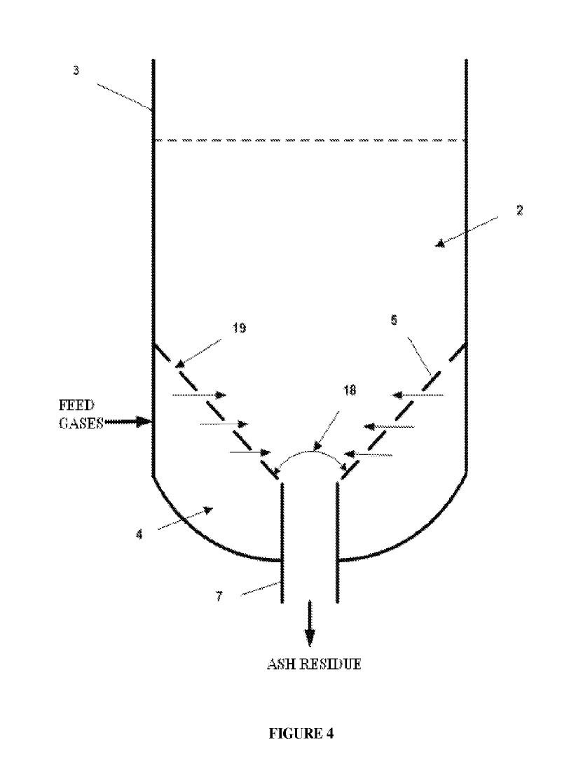

A preferred embodiment of the feed gas distribution grid of the present invention is schematically illustrated in FIG. 4. As shown in FIG. 4, the distribution grid 5 comprises a conical-shaped metal plate with a number of small holes 19 drilled through the grid plate horizontally, or otherwise pointed away from the direction of flow of the solids residue in the fluidized bed region. In a preferred embodiment, the conical grid has a specific included cone angle 18 of about 60-120 degrees, which is found to promote solids circulation in the fluidized bed region 2 as well as to facilitate the discharge of solids residue from the fluidized bed. The combination of the conical grid and the center jet allows the solids in the fluidized bed 2 to move upward and toward the center, then outward radially and downward along the vertical wall of the gasifier and the surface of the grid 3, and finally to return to the center region of the fluidized bed. The conical grid also facilitates the solids residue rolling down the surface of the grid and entering the ash discharge line 7 located at the bottom of the gasifier.

The diameter and number of the grid holes 19 are designed to create a gas pressure drop ranging from about 5 to about 30 kPa, or otherwise sufficient to allow the feed gases to be uniformly distributed among all grid holes before entering into the fluidized bed 2. For example, the diameter of the grid holes may range from 3 to 10 mm. The feed gases flow through the grid holes at a velocity ranging from 30 to 120 m/s and provide a penetrating jet ranging from 20 to 80 mm into the fluidized bed to keep the feed solids in a fully suspended or fluidized state and to prevent undesired caking or sintering of solids on the distribution grid. The high velocity through the grid holes and the resulting jet penetrations create an active grid zone immediately above the entire surface of the conical grid where rapid solids and gas mixing, heat and mass transfer, and gasification reactions occur. The solids rolling down the grid surface are further reacted in the grid zone before entering the ash discharge line 7. This special feature increases the overall utilization or conversion efficiency.

The total number and spacing pattern of the grid holes 19 are designed to provide a complete and uniform coverage for the entire cross-sectional area of the fluidized bed 2. The spacing pattern is designed to minimize the formation of large bubbles resulted from merging of small bubbles generated from the gases leaving the grid holes 19. A fluidized bed with less large bubbles has more efficient gas-solids interfacial transport phenomena and reactions.

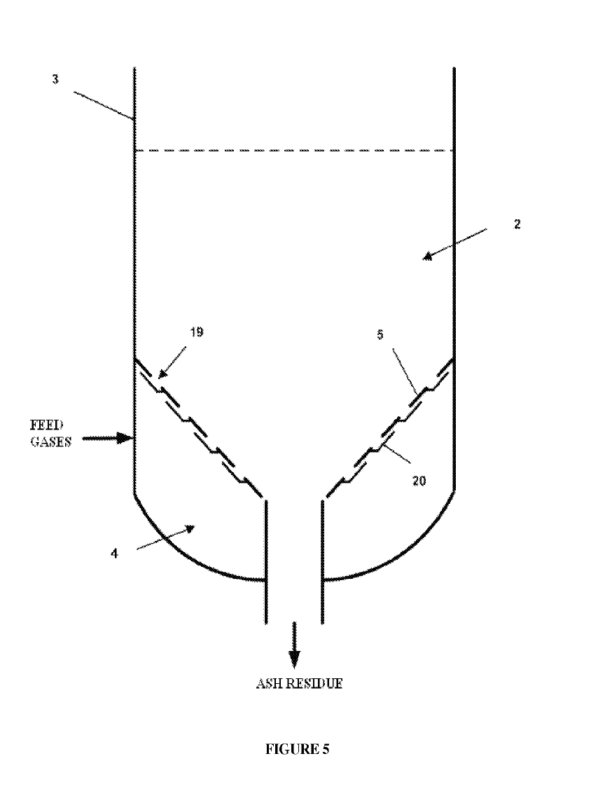

In one embodiment, the present invention provides an improved non-weeping gas distribution grid, which comprises the conical metal plate with the grid holes as described above, and further grid hole covers attached to the grid holes on the underside of the grid or the side opposite to the fluidized bed region. Referring to FIG. 5, in one embodiment, the grid hole cover 20 comprises a suitably shaped (e.g. rectangular) metal channel welded onto to the inlets of each grid holes 19 directly beneath the distribution grid plate. In preferred embodiment, the metal channel has an approximate dimension of 10 to 20 mm×40 to 60 mm.

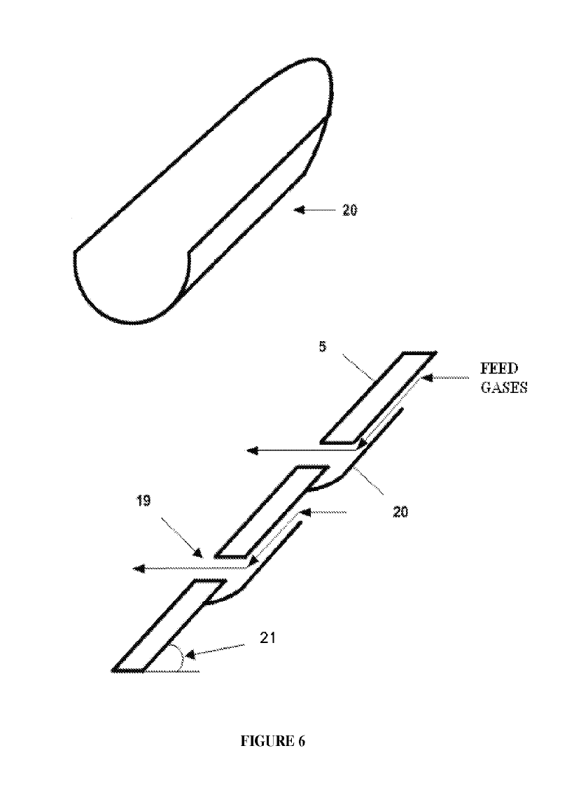

As shown in FIG. 6, a conical distribution grid of the present invention has an inclination angle 23 of about 30-60 degrees to the horizontal line. The grid holes are configured to be parallel to the horizontal line. Feed gases are injected to the fluidized bed through the metal channels and the grid holes at a velocity ranging from 30 to 100 m/s. The combination of the use of horizontally drilled grid holes 19, high velocity through the grid holes, and the grid hole covers prevents the fluidized bed solids flowing or weeping through the grid holes 19 falling into the plenum 2 below the distribution grid 3 and causing undesired combustion reactions of solids in the plenum 2. The improved non-weeping device is less expensive to fabricate, and easier to install, maintain and remove.

What is claimed is:

1. An apparatus for withdrawing solids from a fluidized bed reactor,
wherein the fluidized bed reactor comprises a fluidized bed region encased in a reaction vessel, and a perforated distribution plate through which a portion of feed gas is distributed to the fluidized bed region, which distribution plate forms a funnel having a wide mouth end and a narrow stem end pointing downward,
the apparatus comprising
(1) a venturi tube which comprises a constricted cylindrical venturi throat, a first conical portion extending upward above the venturi throat, and a second conical portion below the venturi throat, wherein the first conical portion is connected to the stem end of the conical distribution plate, and
(2) a center jet pipe enclosed within the venturi, wherein a jet stream of feed gas is delivered above the venturi throat.

2. The apparatus according to claim 1, wherein the perforated distribution plate is equipped with multiple horizontally- or downwardly-oriented grid holes through which the feed gases flow and enter the fluidized bed.

3. The apparatus according to claim 2, wherein the distribution plate has an included cone angle of about 60 to 120° C.

4. The apparatus according to claim 2, wherein the grid holes are sized and spaced to provide a uniform distribution of feed gases, improved solids circulation pattern, and thorough gas-solids mixing in the fluidized bed gasifier.

5. The apparatus according to claim 4, wherein the grid holes are sized and spaced to provide a gas pressure drop across the distribution plate of about 5 to about 30 kPa.

6. The apparatus according to claim 4, wherein the grid holes are sized and spaced to provide a feed gas flow through the grid holes at a velocity of about 30 to about 120 m/s.

7. The apparatus according to claim 2, wherein entrances of the grid holes are placed beneath the distribution plate, and are covered with covers to prevent solids from flowing into the grid holes and falling into the plenum below the distribution plate.

8. The apparatus according to claim 7, wherein the covers are configured such that the feed gas is channeled in a down-ward direction along the distribution plate before flowing into the grid holes.

9. The apparatus according to claim 1, further comprising a classifier pipe which is connected to the second conical portion of the venturi.

10. The apparatus according to claim 1, wherein a feed gas inlet is provided on a lower end of the classifier, wherein solids discharged from the venturi throat enter the classifier immediately below the venturi and further react with up-flowing feed gas.

11. An apparatus according to claim 1, wherein the venturi is engineered to be readily removable from the rest of the gasifier reactor.

12. A fluidized bed reactor that comprises a fluidized bed region encased in a reaction vessel, and a perforated distribution plate through which a portion of feed gas is distributed to the fluidized bed region, which distribution plate forms a funnel having a wide mouth end and a narrow stem end pointing downward, wherein the fluidized bed reactor comprises an apparatus that comprises:
(1) a venturi tube which comprises a constricted cylindrical venturi throat, a first conical portion extending upward above the venturi throat, and a second conical portion below the venturi throat, wherein the first conical portion is connected to the stem end of the conical distribution plate, and
(2) a center jet pipe enclosed within the venturi, wherein a jet stream of feed gas is delivered above the venturi throat.

13. The fluidized bed reactor according to claim 12, wherein the perforated distribution plate is equipped with multiple horizontally- or downwardly-oriented grid holes through which the feed gases flow and enter the fluidized bed.

14. The fluidized bed reactor according to claim 13, wherein the distribution plate has an included cone angle of about 60 to 120° C.

15. The fluidized bed reactor according to claim 14, wherein the grid holes are sized and spaced to provide a gas pressure drop across the distribution plate of about 5 to about 30 kPa.

16. The fluidized bed reactor according to claim 14, wherein the grid holes are sized and spaced to provide a feed gas flow through the grid holes at a velocity of about 30 to about 120 m/s.

17. The fluidized bed reactor according to claim 13, wherein entrances of the grid holes are placed beneath the distribution plate, and are covered with covers to prevent solids from flowing into the grid holes and falling into the plenum below the distribution plate.

18. The fluidized bed reactor according to claim 17, wherein the covers are configured such that the feed gas is channeled in a down-ward direction along the distribution plate before flowing into the grid holes.

19. The fluidized bed reactor according to claim 12, wherein a feed gas inlet is provided on a lower end of the classifier, wherein solids discharged from the venturi throat enter the classifier immediately below the venturi and further react with up-flowing feed gas.

20. The fluidized bed reactor according to claim 12, wherein the venturi is engineered to be readily removable from the rest of the gasifier reactor.
